(19) United States
(12) Patent Application Publication
(10) Pub. No.: US 2023/0398705 A1
(43) Pub. Date: Dec. 14, 2023

(54) WORKSITE APPLICATION TOOL FOR TAPE OR FILM

(71) Applicant: Ethan Faria, Meredith, NH (US)

(72) Inventor: Ethan Faria, Meredith, NH (US)

(21) Appl. No.: 17/836,515

(22) Filed: Jun. 9, 2022

(51) Int. Cl. B26B 11/00; B32B 37/10

(52) U.S. Cl. CPC B26B 11/008; B32B 37/10; B26B 1/08

(57) ABSTRACT

The present disclosure provides an apparatus for applying forces to a tape or a film. In one aspect, the apparatus has an edge for pressing and pushing tape or film uniformly across a surface, an operable light emitting device for illumination, a cutting blade, and a receptacle for a leash or lanyard. The receptacle for a leash or lanyard may be used to secure the apparatus to a belt, harness or other item, and to enable use of other tools without risking loss or damage of the apparatus.

### BACKGROUND

The present disclosure relates to a worksite tool for applying forces to tapes and/or films, so as to ensure that there are no bubbles or wrinkles.

Tapes and films are well known items that serve a variety of functions. For example, they can be used to fasten or connect items, seal gaps and protect surfaces. They may also be used, as a further example, for cosmetic purposes or for their refractive or insulating qualities. However they are used, they are often applied to surfaces using a tool commonly known as a squeegee. Squeegees are used to press and push tapes and films uniformly across a surface, ensuring that there are no bubbles or wrinkles (“smoothing”). Squeegees can come in a variety of shapes and sizes, depending on the application, so long as the device has an edge or surface for smoothing types of tape or film. FIG. 3 depicts a conventional squeegee having a shape commonly used in the industry. It will be noted that the smoothing edges of the prior art squeegee result from tapering sides 310 and 320 of a main body that proceed from centrally-located protrusions.

Some applications require squeegees to be used in non-ideal working conditions. In the construction industry, for example, professionals that install heating, ventilation or air conditioning systems may apply tape to seal or connect ducts in cramped, poorly lit areas such as attics or crawl spaces. Hazards such as gaps in walls and floors are common in such areas, and are often the reason for lost or broken squeegees and other tools. In the shipping and moving industries, professionals may apply tape to packaging or to box items in a warehouse for delivery or storage. Such warehouses may be highly trafficked areas, requiring those professionals to move to different areas depending on changing tasks or responsibilities. In yet another example, automobile customizers may apply films in the course of performing custom body detailing or window tinting. In performing those services, automobile customizers often must work in large open areas or transient worksites, rely on ambient lighting or their own light source, and bring their own equipment.

Tools can become lost or damaged in these environments, for example, due to cramped spaces, open walls or floors, poor lighting, or a high volume of traffic through the worksite. Moreover, professionals are frequently limited to hand-carrying a small number of tools into the worksite, and removing them from the site at the end of the work period. Professionals may also have to secure tools on their person in order to free their hands to use other tools, and because there are limited surfaces to leave their tools safely and securely.

### SUMMARY

The present disclosure provides an apparatus for performing several operations with tape or film in non-optimum environments, and that is small and lightweight and may be carried in a pocket onto a worksite or secured to a leash or lanyard, in order to allow a user to operate other hand tools and to prevent loss or damage.

In one aspect, the apparatus comprises an edge for smoothing tape or film, an operable light emitting device for illumination, and a receptacle for a leash or lanyard.

In another aspect, the apparatus comprises an edge for smoothing tape or film, a cutting blade, and a receptacle for a leash or lanyard.

In still another aspect, the apparatus comprises an edge for smoothing tape or film, an operable light emitting device for illumination, a cutting blade, and a receptacle for a leash or lanyard.

### BRIEF DESCRIPTION OF THE DRAWINGS

FIG. 1 illustrates a perspective view of an apparatus for applying tape or film according to an embodiment.

FIG. 2 illustrates a perspective view of an apparatus for applying tape or film according to another embodiment.

FIG. 3 depicts a conventional squeegee having a shape commonly used in the industry.

### DETAILED DESCRIPTION

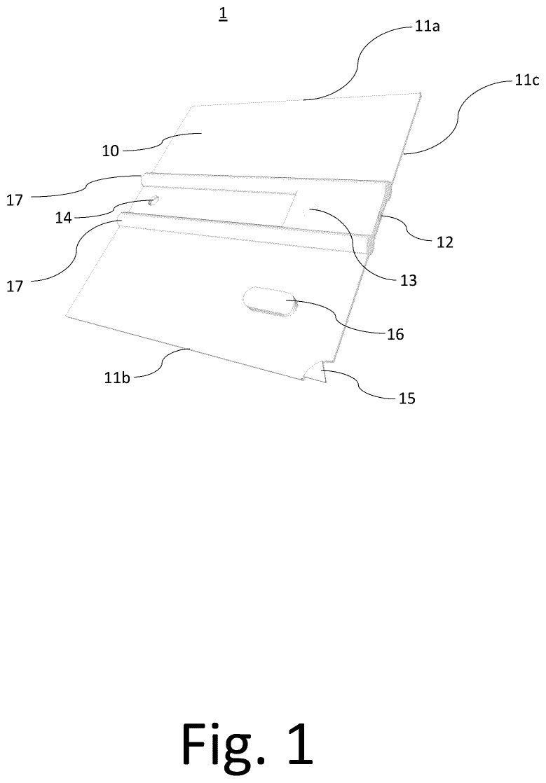

FIG. 1 illustrates an embodiment of a squeegee 1 with a main body 10 (e.g., a card-shaped frame) 10, straight edges 11a and 11b at opposite sides of main body 10, a light emitting device 12 with activation switch 13, a leash receptacle 14, a cutting blade 15 at a corner of main body 10, and a retracting knob 16 to move cutting blade 15 in and out of main body 10. Main body 10 can be made of hard plastic and/or any other suitable materials. It is appreciated that, in some embodiments, squeegee 1 may not include light emitting device 12, switch 13, cutting blade 15, and/or retracting knob 16.

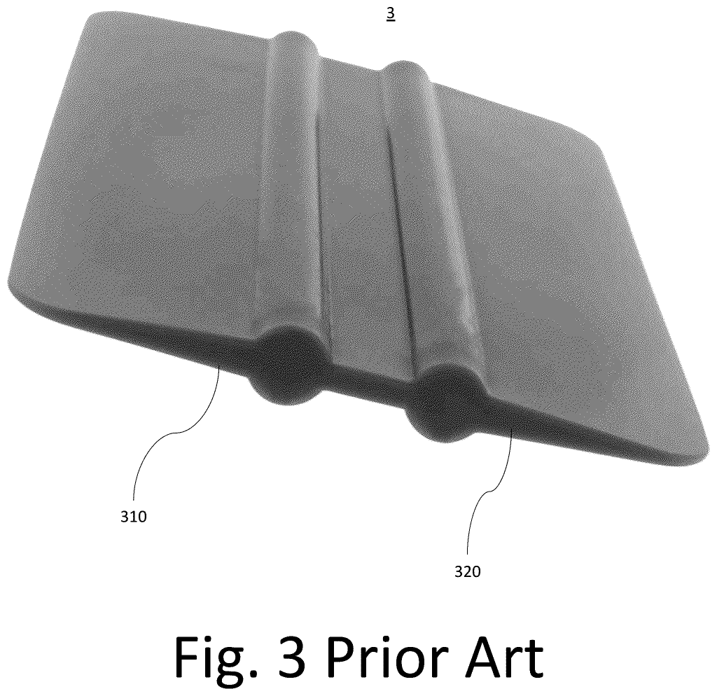

As shown in FIG. 1, squeegee 1 also includes two protrusive ridges 17 arranged on main body 10 that are substantially parallel to edges 11a and 11b. It is appreciated that protrusive ridges 17 can apply structural strength to main body 10. One of ordinary skill in the art also recognizes that, in some embodiments, protrusive ridges 17 and the portion of main body 10 between protrusive ridges 17 may be replaced by a centerline portion having a thickness greater than that of other portions of main body 10. In some embodiments, main body 10 may taper in thickness from protrusive ridges 17 to edges 11a and 11b, similar to that shown in FIG. 3. A user can hold squeegee 1 in hand at protrusive ridges 17 so as to conveniently apply forces to, e.g., tapes and films, via edges 11a or 11b. In this embodiment, light emitting device 12 and switch 13 can be installed in main body 10 between protrusive ridges 17, with light emitting device 12 being configured to emit light out of edge 11c.

Squeegee 1 enables a user to perform several operations with tape or film without the need to carry a separate squeegee, flashlight and cutter. In the example embodiment, main body 10 appears as a square, though one of ordinary skill will recognize that other shapes (for example, rectangles, t-shapes and semicircles) are possible.

Edges 11a and 11b allow a user to smooth tape or film over a variety of surfaces such as metal ducts, cardboard containers, auto bodies or windshields. A user may grasp the apparatus with edge 11a exposed and simultaneously push and press edge 11a across and over a section of tape or film to be uniformly applied over a surface.

Light emitting device 12 can be activated using switch 13 such that a user can illuminate surfaces in poor and ambient lighting conditions to ensure adequate view of the application area and surrounding environment. When a user desires illumination, switch 13 may be pressed or swiped. Similarly, switch 13 may be pressed or swiped again when illumination is no longer needed. In some embodiments, light emitting device 12 (including, e.g., a light emitting diode, a battery, and other circuits) and switch 13 may be embedded within the thickened centerline portion of main body 10.

Leash receptacle 14 enables a user to attach squeegee 1 to a leash or lanyard. As shown in FIG. 1, receptacle 14 is formed on main body 10 between protrusive ridges 17 proximate edge lid. One of ordinary skill in the art recognizes that the leash receptacle comprises a hole or slot that can accommodate, for example, a snap button, buckle, clip, strand, strap, velcro or other common fastener associated with widely available leashes and lanyards. One of ordinary skill in the art further recognizes that the receptacle, when attached to leashes of the retractable variety, enables a user to operate squeegee 1 even while squeegee 1 remains secured to the user's belt, equipment harness or other item.

Optional cutting blade 15 and retracting knob 16 enable a user to cut appropriate-sized portions of tape and film according to the user's need. When desired, a user slides retracting knob 15 forward to extend cutting blade 15. Similarly, a user slides retracting knob 15 backward to retract cutting blade 15. In some embodiments, squeegee 1 may comprise optional cutting blade 15 in a fixed position and will not include retracting knob 16. Other embodiments may not include either optional cutting blade 15 or retracting knob 16, according to users' needs and desired configurations.

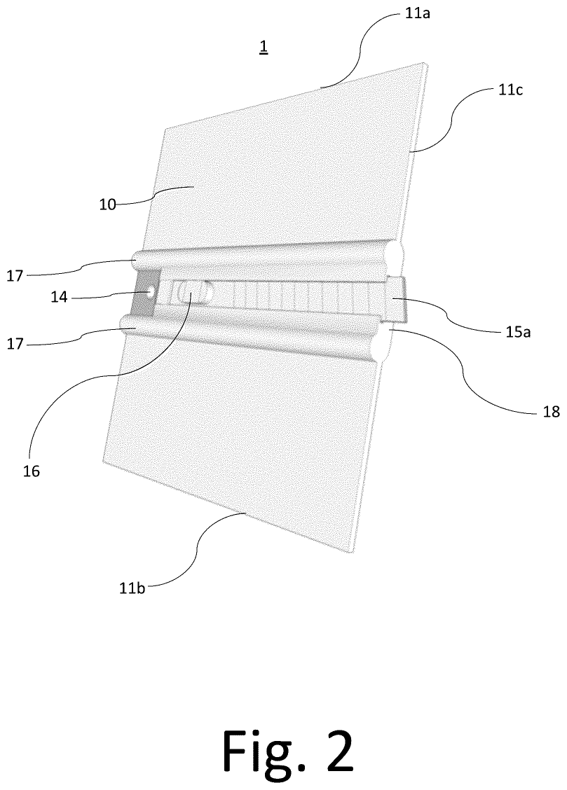

FIG. 2 illustrates an alternate embodiment of squeegee 1 with a detachable cutting blades 15a. As shown in FIG. 2, squeegee 1 includes two protrusive ridges 17 arranged on main body 10 that are substantially parallel to edges 11a and 11b. In this embodiment, detachable cutting blades 15a is formed on main body 10 between protrusive ridges 17. One of ordinary skill recognizes detachable cutting blades 15a as “snap” blades popular in the industry. When a user determines that the leading edge of detachable cutting blades 15a has diminished cutting properties due to use or damage, the user may snap off the leading edge of cutting blade 15a and extend it to a desired length using retracting knob 15. Similarly, a user may substantially retract detachable cutting blades 15a with retracting knob 16 when the detachable cutting blades 15a are not used. In some embodiments, light emitting device 12 and switch 13 may be installed underneath detachable cutting blades 15a, between protrusive ridges 17 and proximate edge 11c. In some embodiments, light emitting device 12 and switch 13 may be embedded underneath detachable cutting blades 15a within a thickened centerline portion of main body 10.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical value appearing in the present disclosure is deemed modified by a term of degree (e.g., “about”), thereby reflecting its intrinsic uncertainty.

Although various embodiments of the present disclosure have been described in detail herein, one of ordinary skill in the art would readily appreciate modifications and other embodiments without departing from the spirit and scope of the present disclosure as stated in the appended claims.

What is claimed is:

1. An apparatus for applying forces to a tape or a film, comprising:
a main body;
a smoothing edge at a first side of the main body;
a receptacle for a leash or lanyard disposed proximate a second side of the main body; and
a light emitting device disposed proximate a third side of the main body.

2. The apparatus of claim 1, further comprising two protrusive ridges on the main body.

3. The apparatus of claim 2, wherein the protrusive ridges are parallel to each other.

4. The apparatus of claim 3, wherein the receptacle and the light emitting device are disposed between the protrusive ridges.

5. The apparatus of claim 4, further comprising a cutting blade disposed between the protrusive ridges and underneath the light emitting device.

6. The apparatus of claim 5, further comprising a retracting knob on the main body to move the cutting blade in and out of the main body.

7. The apparatus of claim 1, further comprising a cutting blade at a corner of the main body.

8. The apparatus of claim 7, further comprising a retracting knob on the main body to move the cutting blade in and out of the main body.

9. The apparatus of claim 1, further comprising an activation switch on the main body to turn on and off the light emitting device.

10. The apparatus of claim 1, wherein the main body includes a centerline portion having a thickness greater than that of other portions of the main body.

11. The apparatus of claim 10, wherein the light emitting device is disposed within the centerline portion of the main body.

12. The apparatus of claim 11, further comprising a cutting blade disposed within the centerline portion of the main body and underneath the light emitting device.

13. The apparatus of claim 12, further comprising a retracting knob on the main body to move the cutting blade in and out of the main body.

14. An article of manufacture, comprising:
the apparatus of claim 1; and
a retractable leash attached to the receptacle of the apparatus.

15. An apparatus for applying forces to a tape or a film, comprising:
a main body;
a smoothing edge at a first side of the main body;
a receptacle for a leash or lanyard disposed proximate a second side of the main body;
two protrusive ridges on the main body, the protrusive ridges being parallel to each other; and
a cutting blade disposed on the main body between the protrusive ridges.

16. The apparatus of claim 15, further comprising a retracting knob on the cutting blade to move the cutting blade in and out of the main body.

17. An article of manufacture, comprising:
the apparatus of claim 15; and
a retractable leash attached to the receptacle of the apparatus.

18. An apparatus for applying forces to a tape or a film, comprising:
a main body;
a smoothing edge at a first side of the main body;
two parallel protrusive ridges on the main body;
a receptacle for a leash or lanyard disposed on the main body between the protrusive ridges and proximate a second side of the main body;
a light emitting device disposed on the main body between the protrusive ridges and proximate a third side of the main body; and
a cutting blade at a corner of the main body.

19. The apparatus of claim 18, further comprising a retracting knob on the main body to move the cutting blade in and out of the main body.

20. The apparatus of claim 18, further comprising an activation switch on the main body between the protrusive ridges to turn on and off the light emitting device.
